(19) United States
(12) Patent Application Publication
(10) Pub. No.: US 2016/0381441 A1
(43) Pub. Date: Dec. 29, 2016

(54) OPTICAL TRANSMISSION DEVICE, OPTICAL TRANSMISSION SYSTEM, AND OPTICAL TRANSMISSION METHOD

(71) Applicant: Fujitsu Limited, Kawasaki-shi (JP)

(72) Inventors: Kazuaki Nagamine, Ota (JP); Ichiro Nakajima, Koto (JP)

(73) Assignee: Fujitsu Limited, Kawasaki-shi (JP)

(21) Appl. No.: 14/304,113

(22) Filed: Jun. 13, 2014

(30) Foreign Application Priority Data
Jul. 11, 2013 (JP) 2013-145859

(51) Int. Cl. H04Q 11/00; H04B 10/50; H04J 14/02

(52) U.S. Cl. CPC H04Q 11/0005; H04J 14/0212; H04B 10/503; H04Q 2011/0009; H04Q 2011/0049

(57) ABSTRACT

An optical transmission device includes: a wavelength filter configured to allow passage of an optical signal having a band; a monitor configured to monitor a wavelength of the optical signal; and a controller configured to detect, based on a monitoring result of the monitor, a change in the wavelength of the optical signal, to predict, based on the detected result, a direction of the change in the wavelength of the optical signal, and to expand a passband of the wavelength filter in the direction of the change.

### CROSS-REFERENCE TO RELATED APPLICATION

This application is based upon and claims the benefit of priority of the prior Japanese Patent Application No. 2013-145859, filed on Jul. 11, 2013, the entire contents of which are incorporated herein by reference.

### FIELD

The embodiments discussed herein are related to an optical transmission device, an optical transmission system, and an optical transmission method.

### BACKGROUND

With increasing demands for communication, optical networks utilizing wavelength division multiplexing (WDM) technology have become widespread. WDM technology is a technology that multiplexes and transmits a plurality of optical signals having different wavelengths.

By using WDM technology, it is possible to multiplex, for example, optical signals to be transmitted at a transmission rate of 40 Gbps for each of 88 wavelengths and transmit them as a wavelength-multiplexed optical signal (hereinafter referred to as a “multiplexed optical signal”). A reconfigurable optical add-drop multiplexer (ROADM), for example, is known as a WDM transmission device utilizing WDM technology.

Regarding the spectrum of a multiplexed optical signal, optical signals have wavelengths that are at a uniform interval of, for example, 50 GHz or 100 GHz. This wavelength interval is called an ITU-T (International Telecommunication Union Telecommunication Standardization Sector) grid or the like, and is widely used for WDM transmission devices.

Recently, in the anticipation that the demands for communication will increase in the future, application of a multi-level modulation method, such as dual polarization quadrature phase-shift keying (DP-QPSK), used for wireless communication to a WDM transmission device to achieve coherent transmission has been attempted. Therefore, it is desired that, with a WDM transmission device, optical signals having various communication capacities that are different not only in terms of transmission rate but also in terms of modulation method be accommodated in a multiplexed optical signal.

Therefore, a flexible grid technique has been developed in which the wavelength interval is variable, so that optical signals with various bandwidths are flexibly accommodated in a multiplexed optical signal. The flexible grid technique is defined in ITU-T recommendation G.694.1. By using the flexible grid technique, unlike in the case where a fixed wavelength interval, such as the ITU-T grid, is used, a wavelength interval between optical signals whose spectra are adjacent to each other may be set based on a minimum band in accordance with what type of signal these optical signals are. For this reason, the transmission capacity for each optical fiber increases, and thus the wavelength accommodation efficiency improves.

However, for example, when an optical signal during operation is replaced by another optical signal with a bandwidth different from that of the optical signal during operation, a difference in passband width between the optical signals before and after the replacement causes an unused, fragmented region to be produced between spectra of adjacent optical signals. This leads to a problem in that, as the replacement of optical signals progresses, the size of fragmented regions increases and thus the wavelength accommodation efficiency of an optical fiber decreases.

To address this, Kyosuke Sone et al., “First Demonstration of Hitless Spectrum Defragmentation using Real-time Coherent Receivers in Flexible Grid Optical Networks”, ECOC 2012, and F. Cugini et al., “Push-Pull Technique for Defragmentation in Flexible Optical Networks”, JTh2A, OFC2012 disclose a non-disruptive defragmentation technology in which the fragmented regions mentioned above are reduced by changing the wavelength of a tunable laser at a sending node and the passband of a wavelength filter at a relay node in synchronization with each other.

Additionally, regarding wavelength control, it is disclosed, for example, in Japanese Laid-open Patent Publication No. 2011-160146 that, in wavelength division multiplexing communication of a coherent transmission method, when an error of a received signal is detected, the wavelength of local oscillation light of a receiver is changed to a wavelength stored in a storage unit. Additionally, regarding a wavelength filter, it is disclosed in Japanese Laid-open Patent Publication No. 2011-254309 that, in a wavelength multiplexing device, a deviation of the wavelength transmission property of a filter is detected based on a difference between spectra acquired by the input-side optical channel monitor (OCM) and the output-side OCM.

In the case of using the non-disruptive defragmentation technology mentioned above, control over wavelength multiplexing transmission devices provided at a sending node, which serves as the sending source of optical signals, and at a relay node for relaying optical signals is performed by an external control device such as a network management device. Additionally, in some cases, control over a wavelength multiplexing transmission device at a receiving node for receiving optical signals is performed. In the control, for example, a series of sequential processes described below is performed.

First, the passband of a wavelength filter, which is a wavelength selective switch (WSS) at each relay node, is expanded by a predetermined amount. Next, within the expanded passband, the wavelength of a tunable laser (sender) is caused to slide (displaced) slightly (for example, by an amount corresponding to 2.5 GHz). Then, the passband of the wavelength selective switch at each relay node is reduced by the predetermined amount. Repeating the sequential processes changes the wavelength of an optical signal during operation to a desired value, without disrupting the optical signal. For this reason, the intervals between spectra are optimized, and thus the fragmented regions mentioned above are reduced and the wavelength accommodation efficiency improves.

However, when the non-disruptive defragmentation technology is used, the larger the scale of a network of wavelength multiplexing transmission devices, the larger the number of nodes are to be controlled. Therefore, there is a problem in that, as well as an increase in communication traffic between the control device mentioned above and each node, an increase in the time used for the entire control is caused by an increase in the standby time and so on used for synchronous processing. Furthermore, there is a problem in that operations of a control device become complicated because control becomes complicated.

Accordingly, it is desired that a wavelength multiplexing transmission device at each relay node autonomously change the passband of a wavelength filter in accordance with the wavelength of an optical signal, without depending on control by a control device. However, there has been no way of changing the passband for an optical signal without disrupting the optical signal during operation.

### SUMMARY

According to an aspect of the embodiments, an optical transmission device includes: a wavelength filter configured to allow passage of an optical signal having a band; a monitor configured to monitor a wavelength of the optical signal; and a controller configured to detect, based on a monitoring result of the monitor, a change in the wavelength of the optical signal, to predict, based on a result detected by the monitor, a direction of the change in the wavelength of the optical signal, and to expand a passband of the wavelength filter in the direction of the change.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a configuration of a network;

FIG. 2A and FIG. 2B are waveform charts illustrating examples of spectral waveforms of multiplexed optical signals in the case where an ITU-T grid is employed and in the case where a flexible grid is employed, respectively;

FIG. 3A and FIG. 3B are waveform charts illustrating states of production of fragmented regions before replacement of optical signals and after the replacement, respectively;

FIG. 4 is a schematic block diagram illustrating a configuration of an optical transmission system according to an embodiment;

FIG. 5A, FIG. 5B, FIG. 5C, and FIG. 5D illustrate control operations of a passband performed by a WSS controller;

FIG. 6 is a flowchart illustrating a process of expanding the passband;

FIG. 7 illustrates a method for inspecting a wavelength filter;

FIG. 8 is a flowchart illustrating a process of reducing the passband;

FIG. 9 illustrates a limitation on wavelength intervals;

FIG. 10 is a schematic block diagram illustrating a configuration of a transmission system according to another embodiment; and

FIG. 11 is a schematic block diagram illustrating an example of a functional configuration of a wavelength selective switch.

### DESCRIPTION OF EMBODIMENTS

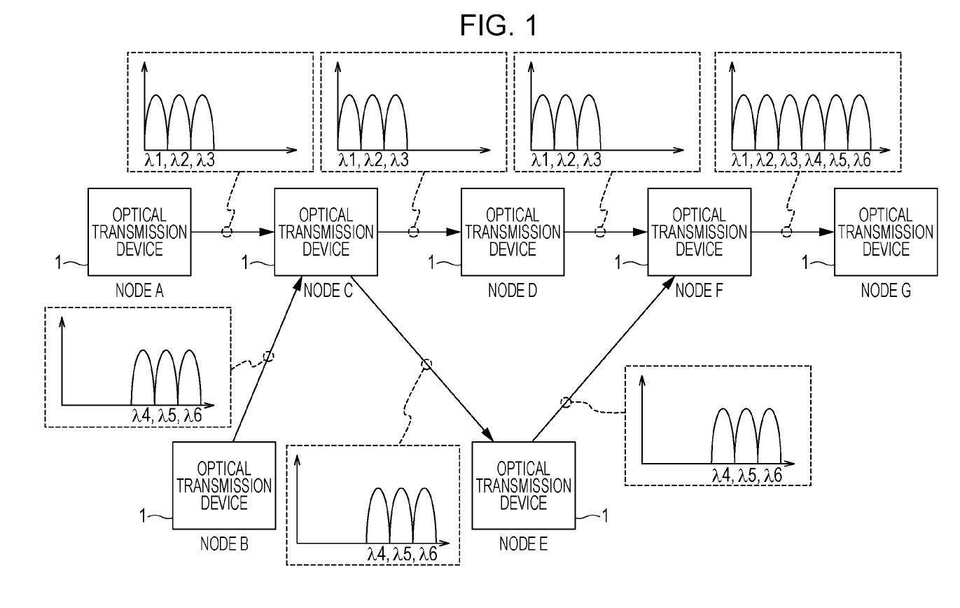

FIG. 1 is a schematic diagram illustrating an example of a configuration of a network. The network has a plurality of nodes A to G. An optical transmission device 1 is provided at each of the nodes A to G. The optical transmission device 1 is a wavelength multiplexing transmission device, such as an ROADM device, and, for example, multiplexes a plurality of optical signals having different wavelengths of λ1 to λ6 and transmits them as a multiplexed optical signal.

The optical transmission devices 1 of the nodes A to G are connected through transmission paths (optical fiber). In FIG. 1, each of the graphs enclosed by a dotted line is a graph depicting spectral waveforms of a multiplexed optical signal to be transmitted through a corresponding transmission path.

A multiplexed optical signal containing optical signals having wavelengths of λ1 to λ3 is transmitted through a transmission route from the node A via the node C and the node D to the node F. A multiplexed optical signal containing optical signals having wavelengths of λ4 to λ6 is transmitted through a transmission route from the node B via the node C and the node E to the node F. The optical transmission device 1 of the node F combines multiplexed optical signals that have passed through the above two transmission routes into one multiplexed optical signal and transmits it to the optical transmission device 1 of the node G. For this reason, a multiplexed optical signal in which optical signals having the wavelengths of λ1 to λ6 are multiplexed is transmitted through the transmission path between the nodes F and G.

In this way, over a network of WDM transmission devices, optical signals having arbitrary wavelengths of λ1 to λ6 may be transmitted among arbitrary nodes A to G. Accordingly, in the network, the higher the wavelength accommodation efficiency of each transmission path is, the more the transmission capacity increases.

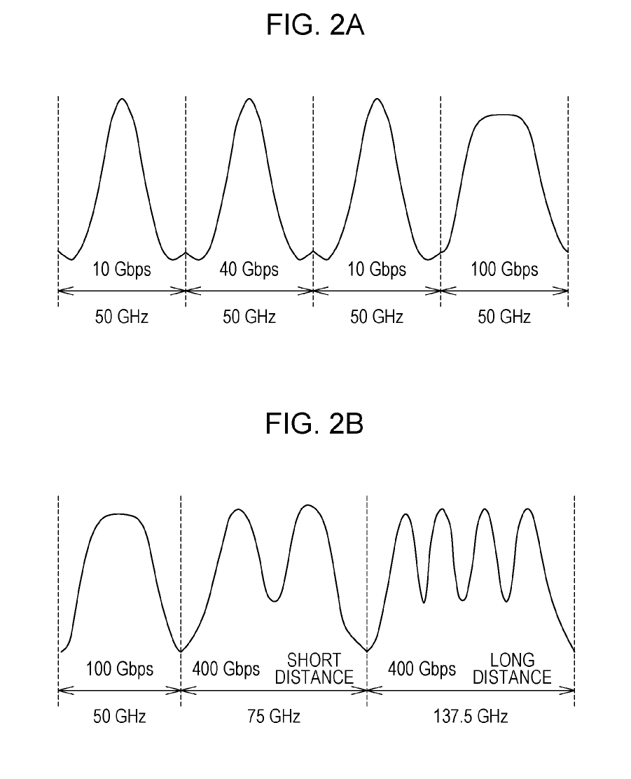

FIG. 2A and FIG. 2B are waveform charts illustrating examples of spectral waveforms of multiplexed optical signals in the case where an ITU-T grid is employed and in the case where a flexible grid is employed, respectively. In the case of the ITU-T grid (FIG. 2A), four optical signals having transmission rates of 10 Gbps, 40 Gbps, 10 Gbps, and 100 Gbps are accommodated at the same wavelength interval (50 GHz). That is, a uniform passband (50 GHz) is assigned to each optical signal.

In contrast, in the case of the flexible grid (FIG. 2B), the wavelength intervals between optical signals are not uniform. Passbands of 50 GHz, 75 GHz, and 137.5 GHz are assigned to optical signals having transmission rates of 100 Gbps, 400 Gbps (for short distance), and 400 Gbps (for long distances), respectively.

In such a manner, by employing a flexible grid, wavelength intervals between optical signals whose spectra are adjacent to each other (adjacent channels) may be set not to a uniform interval but flexibly to minimum wavelength bands in accordance with the transmission rates of optical signals. Accordingly, with the flexible grid technology, the wavelength utilization efficiency for each optical fiber may be improved.

However, for example, if an optical signal during operation is replaced by another optical signal with a bandwidth different from that of the optical signal during operation, an unused, fragmented region is produced between the spectra of the adjacent optical signals because of a difference in bandwidth before and after that replacement. This leads to a problem in that, as the replacement of optical signals progresses, the size of fragmented regions increases and thus the wavelength accommodation efficiency of an optical fiber decreases more than expected.

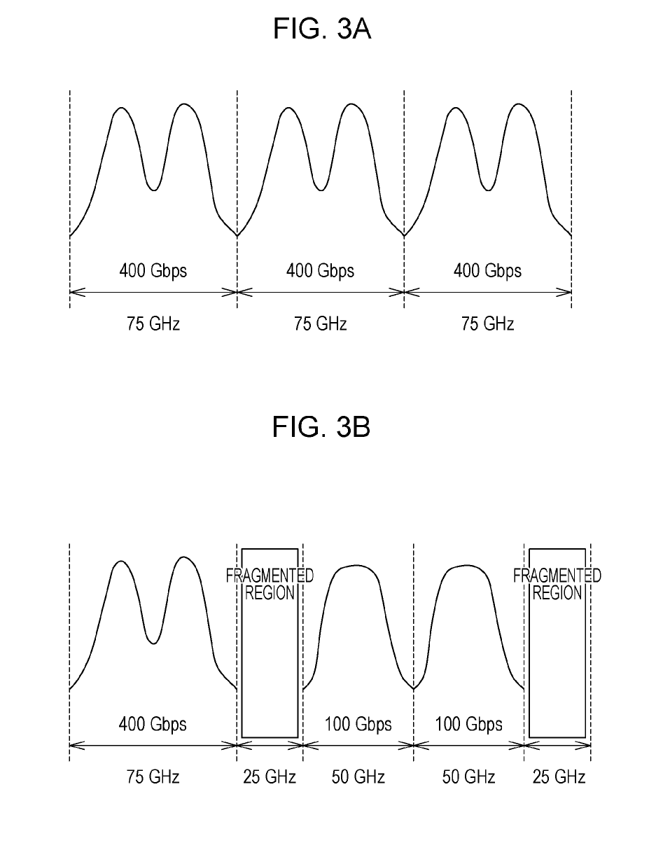

FIG. 3A and FIG. 3B are waveform charts illustrating states of production of fragmented regions before and after replacement of optical signals. Before replacement of optical signals, for example, three optical signals of 400 Gbps are adjacently accommodated (FIG. 3A). Here, the passband for each optical signal is 75 GHz.

Among the three optical signals, two optical signals adjacent to each other are replaced with optical signals of 100 Gbps (FIG. 3B). Here, assuming that each of the passbands for optical signals (100 Gbps) after the replacement is 50 GHz, fragmented regions each having a bandwidth of 25 GHz are produced because of a difference in bandwidth before and after the replacement. This leads to a problem in that, as the replacement of optical signals progresses, the size of fragmented regions increases and thus the wavelength accommodation efficiency decreases.

To address this, it is conceivable to control the wavelengths and passbands for optical signals by using the non-disruptive defragmentation technology described above, thereby reducing the size of fragmented regions. However, as described above, if control is performed by using an external control device, the number of nodes to be controlled is large in a large-scale network and therefore various problems would arise.

Accordingly, in an embodiment, the passband for an optical signal is autonomously changed during operation by predicting, based on a detection result of a change in the wavelength of the optical signal, the direction of change in the wavelength, expanding the passband of a wavelength filter in the direction of change, and reducing the passband in accordance with a changed wavelength.

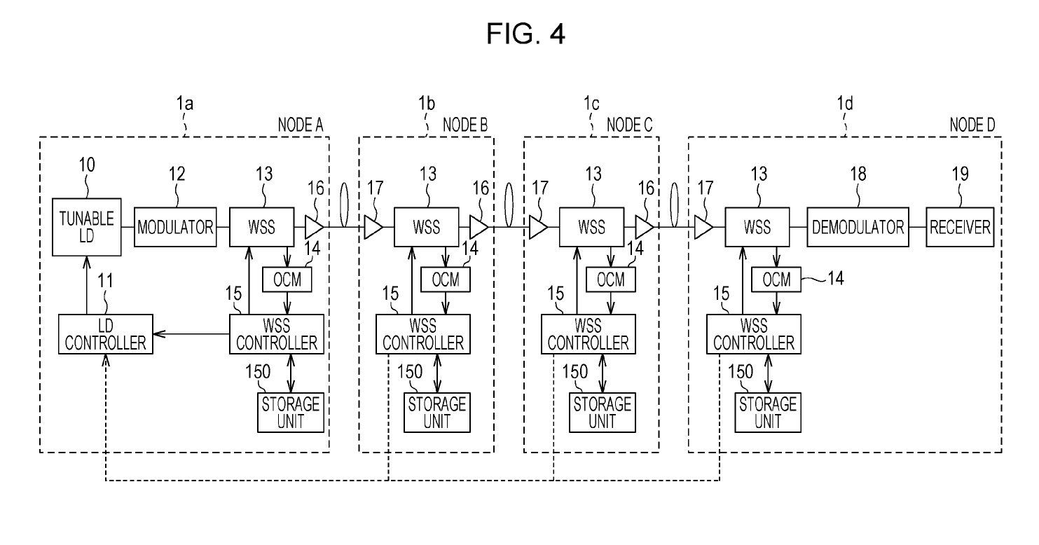

FIG. 4 is a schematic block diagram illustrating a configuration of an optical transmission system according to the embodiment. The optical transmission system has a plurality of optical transmission devices 1a to 1d arranged at the nodes A to D, respectively. The optical transmission devices 1a to 1d are connected in series through transmission paths (optical fiber), and transmit optical signals multiplexed by using the flexible grid technology described above.

The node A is a sending node, the node B and the node C are relay nodes, and the node D is a receiving node. That is, the optical transmission device 1a of the node A transmits optical signals through the optical transmission devices 1b and 1c of the node B and the node C to the optical transmission device 1d of the node D. Although the optical transmission devices 1a to 1d of the nodes A to D have a common configuration, configurations slightly different from one another are illustrated for the nodes A to D in FIG. 4 for the sake of convenience.

The optical transmission device 1a of the node A includes a tunable laser diode (LD) 10, an LD controller 11, a modulator 12, a wavelength selective switch (WSS) 13, an OCM 14, a WSS controller 15, a storage unit 150, and an output amplifier 16. The tunable LD (sender) 10 sends an optical signal whose wavelength is variable to the optical transmission device 1b of the node B.

The LD controller 11 controls the wavelength of an optical signal having a predetermined band. That is, the LD controller 11 controls the wavelength of output light of the tunable LD 10. More particularly, the LD controller 11 changes the wavelength of an optical signal at a uniform change speed, until the wavelength reaches a predetermined target value. At this point, an instruction to perform wavelength control and the target value are given, for example, from an external device to the LD controller 11.

Thereby, the wavelength interval between spectra of optical signals is optimized (for example, minimized), so that the size of fragmented regions is reduced. Note that the LD controller 11 may include a locking circuit for inhibiting wavelength control. In this case, if the lock of the locking circuit is released from an external device or the like when the wavelength is controlled, a change in wavelength caused by a malfunction is avoided.

The modulator 12 modulates an optical signal input from the tunable LD 10. Examples of the modulation method include, but are not limited to, DP-QPSK, when coherent transmission of optical signals is performed. The modulator 12 outputs the modulated optical signal to the wavelength selective switch 13.

The wavelength selective switch 13 functions as a wavelength filter that allows passage of optical signals having selected wavelengths among a plurality of wavelengths. The wavelength selective switch 13 multiplexes optical signals having the selected wavelengths and outputs them as a multiplexed optical signal to the output amplifier 16.

Although not illustrated in the drawing, the wavelength selective switch 13 multiplexes, in addition to optical signals from the tunable LD 10, optical signals inserted in the node A and optical signals input from other nodes. Note that the wavelength selective switch 13 adjusts the width of a passband for every channel to which optical signals are assigned, for example, by controlling a liquid crystal on silicon (LCOS) or a digital micro mirror device (DMD) integrated therein.

The output amplifier 16 amplifies a multiplexed optical signal input from the wavelength selective switch 13 and outputs it to a transmission path. The output amplifier 16 amplifies light, for example, using an erbium-doped fiber.

The OCM (monitor) 14 monitors optical signals output to the transmission path, at a uniform time interval (for example, 2 s). More particularly, the OCM 14 splits a multiplexed optical signal output from the wavelength selective switch 13 into optical signals of every wavelength. The OCM 14 detects the wavelength of each optical signal obtained by the split and outputs it to the WSS controller 15.

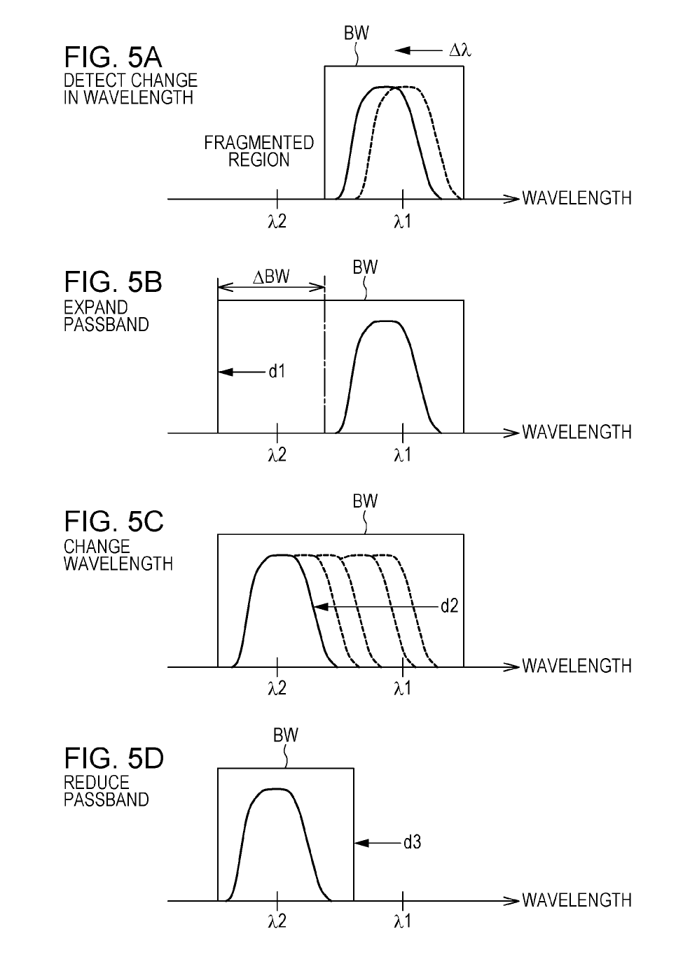

The WSS controller (controller) 15, as in the non-disruptive defragmentation technology described above, autonomously controls the passband of the wavelength selective switch (wavelength filter) 13, without depending on control of an external control device. FIG. 5A, FIG. 5B, FIG. 5C, and FIG. 5D illustrate control operations of a passband performed by a WSS controller. In FIG. 5A, FIG. 5B, FIG. 5C, and FIG. 5D, within solid-line frames a passband BW is illustrated, and the horizontal axis represents the wavelength, instead of the frequency, for the sake of convenience.

As illustrated in FIG. 5A, the WSS controller 15 detects a change Δλ in the wavelength (hereinafter referred to as a “wavelength change Δλ”) of an optical signal using a result of monitoring performed by the OCM 14. As described above, the LD controller 11 controls the wavelength of an optical signal so as to reduce the size of fragmented regions. The direction of control (the direction of change) of the wavelength at this point is a direction in which the spectrum approaches a fragmented region. In this example, the LD controller 11 controls the wavelength of the optical signal so that the wavelength is changed from λ1 to λ2.

The spectra represented by a dotted line and a solid line indicate a result of monitoring performed by the OCM 14 at a point of time when one monitoring cycle has arrived and a result of monitoring performed by the OCM 14 at a point of time when the next monitoring cycle has arrived. The WSS controller 15 detects the wavelength change Δλ, for example, by comparing two spectra. When the difference in wavelength between two spectra is equal to or larger than a predetermined value, for example, the WSS controller 15 may detect the difference as the wavelength change αλ. Alternatively, when that difference in wavelength is recognized continuously a predetermined number of times, the WSS controller 15 may also detect that difference as the wavelength change Δλ. Note that, in order to detect the wavelength change Δλ, whenever the WSS controller 15 acquires the wavelength of an optical signal from the OCM 14, the WSS controller 15 causes the storage unit 150 to store the value of that wavelength.

The WSS controller 15 predicts the direction of change (the direction of control) in the wavelength of the optical signal, based on the result of detection of the wavelength change αλ, and, as illustrated in FIG. 5B, expands the passband BW of the wavelength selective switch (wavelength filter) 13 in a direction of change d1. In this example, the wavelength changes in the left direction (negative direction) of the drawing of FIG. 5A (see Δλ), and therefore the WSS controller 15 predicts that the direction of change in the wavelength will be the left direction. In contrast to this, if the wavelength changes in the right direction (positive direction) of the drawing, the WSS controller 15 predicts that the direction of change in the wavelength will be the right direction.

The WSS controller 15 expands the passband BW in the predicted direction of change. At this point, an amount of expansion ΔBW of the passband BW may be fixed (for example, 12.5 GHz), and may also have a value determined based on the speed of the wavelength change Δλ as described later.

Thereafter, as illustrated in FIG. 5C, the LD controller 11 changes the wavelength of the optical signal to a target value λ2 (see reference character d2) by continuing control of the wavelength. Here, the target value λ2 is the center wavelength of the adjacent grid of the optical signal, for example. At this point, the wavelength is controlled within the range of the expanded passband BW, and therefore there is no case where the spectrum is extruded out of the passband BW and thereby instantaneous disruption of the optical signal occurs. Note that, in FIG. 5C, the waveforms of dotted lines indicate the process in which the spectrum changes.

As illustrated in FIG. 5D, the WSS controller 15 reduces the expanded passband BW in accordance with a changed wavelength of the optical signal (see reference character d3). More particularly, since the wavelength of the optical signal has reached the target value λ2, the WSS controller 15 cuts off the passband of the adjacent grid with the center wavelength Δλ1 that has become unused (unused passband).

Thereby, the passband of the grid with the center wavelength λ1 becomes open, and therefore becomes available as the passband for another optical signal. Note that if the wavelength λ2 is not the target value for wavelength control in the LD controller 11, the process of FIG. 5A to FIG. 5D is repeated until the wavelength of an optical signal is changed to that target value.

Note that the WSS controller 15 may have an enable/disable setting in order to avoid accidentally controlling the passband when the wavelength changes under the influence of noise and so on. In this case, the enable/disable setting is set to the enabled state by an external device when wavelength control is performed, and is set to the disabled state by an external device when wavelength control is completed.

With reference again to FIG. 4, the storage unit 150 is, for example, a storage measure such as a memory, and stores the wavelength of each optical signal that is allowed to pass through the wavelength selective switch 13. The WSS controller 15 sets the wavelength selective switch 13 in accordance with information on a wavelength read from the storage unit 150.

The optical transmission devices 1b and 1c of the node B and the node C each include an input amplifier 17, the wavelength selective switch 13, the OCM 14, the WSS controller 15, the storage unit 150, and the output amplifier 16. The wavelength selective switch 13, the OCM 14, the WSS controller 15, and the output amplifier 16 are as described above.

The input amplifiers 17 amplify multiplexed optical signals input from the optical transmission devices 1a and 1b of the adjacent nodes A and B, and output them to the wavelength selective switches 13. The input amplifier 17 amplifies light, for example, using an erbium-doped fiber. Note that, as described later, the WSS controller 15 may inspect the wavelength selective switch 13 based on power of noise light passing through the wavelength selective switch (wavelength filter) 13, such as amplified spontaneous emission (ASE) light of the input amplifier 17.

The optical transmission device 1d of the node D includes the input amplifier 17, the wavelength selective switch 13, the OCM 14, the WSS controller 15, the storage unit 150, a demodulator 18, and a receiver 19. The input amplifier 17, the wavelength selective switch 13, the OCM 14, the WSS controller 15, and the storage unit 150 are as described above.

The demodulator 18 demodulates an optical signal input from the wavelength selective switch 13. Here, in order to split an optical signal, the wavelength selective switch 13 separates that optical signal from a multiplexed optical signal, and outputs the separated optical signal to the demodulator 18. The demodulator 18 demodulates the optical signal using a demodulation method suitable for the modulator 12 of the sending node A.

The receiver 19 receives an optical signal. In the case of coherent transmission, the receiver 19 receives an optical signal, for example, by detecting an optical signal using local oscillation light as in a heterodyne detection system. In this case, based on a result of monitoring performed by the OCM 14, the receiver 19 may adjust the wavelength of local oscillation light in accordance with the wavelength of an optical signal. The received optical signal is converted, for example, into an electric signal and is sent to another network.

As described above, the WSS controllers 15 of the nodes A to D predict the direction of change in the wavelength of an optical signal that is caused by the LD controller 11, and expands the passband BW for the optical signal in the wavelength selective switch 13 prior to wavelength control. For this reason, the passband BW is expanded before the spectrum of an optical signal moves outside of the passband BW.

Accordingly, with a transmission system according to the embodiment, the passband for an optical signal may be autonomously changed during operation, without instantaneous disruption of the optical signal. In contrast to this, if the passband is controlled so as to simply follow a result of monitoring performed by the OCM 14, it is difficult to avoid instantaneous disruption of an optical signal because the cycle of monitoring performed by the OCM 14 is not short enough relative to the speed of the wavelength change Δλ.

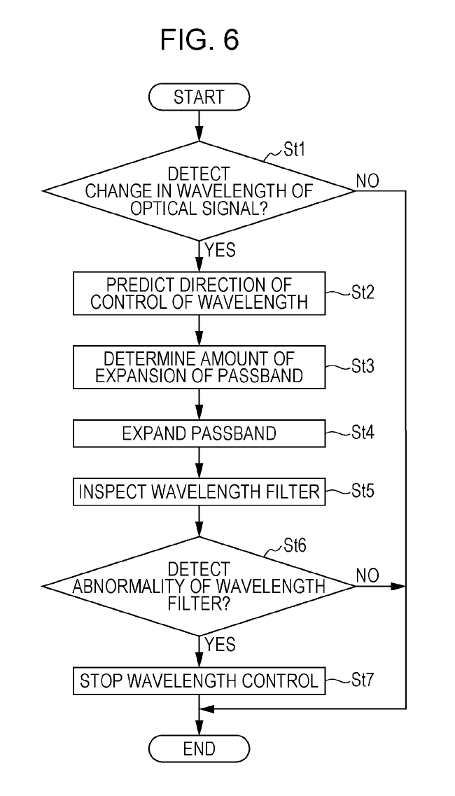

Next, details of control of the passband BW in the WSS controller 15 will be described. FIG. 6 is a flowchart illustrating a process of expanding the passband BW.

First, based on a result of periodic monitoring of optical signals performed by the OCM 14, the WSS controller 15 detects a change in the wavelength of an optical signal (Yes in step St1), and then predicts the direction of change in the wavelength (step St2). This processing is as described with reference to FIG. 5A. If the wavelength change Δλ is not detected (No in step St1), the WSS controller 15 terminates the process.

Next, the WSS controller 15 detects the speed of the wavelength change Δλ using a result of monitoring performed by the OCM 14, and determines the amount of expansion ΔBW of the passband BW based on the speed of the wavelength change (step St3). The WSS controller 15 detects the speed of the wavelength change Δλ by calculating the wavelength change Δλ from results of monitoring in the current monitoring cycle and the previous monitoring cycle and dividing the wavelength change Δλ by the cycle of monitoring (the time interval of monitoring) performed by the OCM 14. Then, from the speed of the wavelength change Δλ, the WSS controller 15 predicts the value of the wavelength in the next monitoring cycle, and determines the amount of expansion ΔBW based on the predicted value. Thereby, the amount of expansion ΔBW is adjusted to an appropriate value.

Next, the WSS controller 15 expands the passband BW in accordance with the determined amount of expansion ΔBW in the predicted direction of change (step St4). This processing is as described with reference to FIG. 5B.

Next, the WSS controller 15 inspects the wavelength selective switch (wavelength filter) 13 based on the power of noise light passing through the wavelength selective switch (wavelength filter) 13 (step St5). At this point, the WSS controller 15 acquires the power of noise light from a result of monitoring performed by the OCM 14. Note that noise light is, for example, ASE light that leaks through the wavelength selective switch 13 from the input amplifier 17.

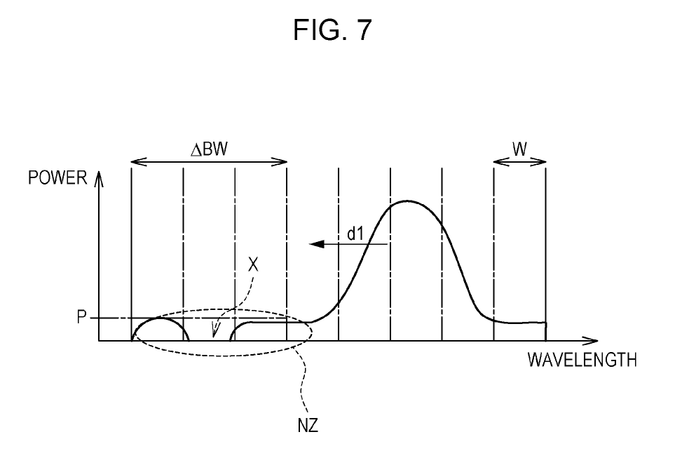

FIG. 7 illustrates a method for inspecting the wavelength filter 13. In FIG. 7, the horizontal axis represents the wavelength, and the vertical axis represents the power of light. Reference character W denotes a minimum bandwidth when the passband BW is controlled, that is, a slot serving as a control unit.

In the range of the bandwidth (expansion) ΔBW expanded in processing of expanding the passband (step St4), noise light NZ passes through the wavelength selective switch 13. For this reason, the OCM 14 detects power P of the noise light NZ within the amount of expansion ΔBW.

However, as denoted by reference character X, when the power P mentioned above is not detected (the output of noise light does not satisfy the predetermined power P) in a specific slot, it is assumed that the wavelength selective switch 13 has a fault. That is, it is considered that the wavelength selective switch 13 is in a state where a fault has occurred in some of the LCOS and DMD integrated therein (in the case of a LCOS, a fault occurs on a pixel-by-pixel basis), and therefore it is impossible for light (noise light) of the slot in question to pass through the wavelength selective switch 13. Accordingly, the WSS controller 15 may detect an abnormality of the wavelength selective switch (wavelength filter) 13 based on the power of noise light.

If an abnormality of the wavelength filter 13 is detected (Yes in step St6), the WSS controller 15 stops control of the wavelength (that is, changing the wavelength) of an optical signal (step St7). More particularly, the WSS controller 15 requests the LD controller 11 to stop wavelength control. At this point, the WSS controllers 15 of the node B to the node D send requests to stop wavelength control, for example, through a monitoring control channel assigned to communication among nodes, to the LD controller 11 of the node A.

In this way, by inspecting the wavelength selective switch 13 before the wavelength of an optical signal is changed, instantaneous disruption of the optical signal caused by an abnormal slot (see reference character X) is avoided. Otherwise, if an abnormality of the wavelength filter 13 is not detected (No in step St6), the WSS controller 15 terminates the process. As such, the process of expanding the passband BW is performed.

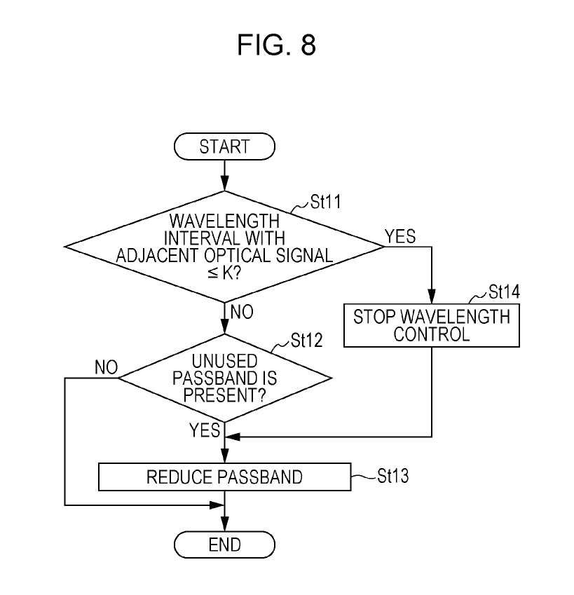

FIG. 8 is a flowchart illustrating a process of reducing the passband BW. First, based on a result of monitoring performed by the OCM 14, the WSS controller 15 determines whether the wavelength interval between an optical signal and another optical signal (the adjacent channel) whose spectrum is adjacent to that of the optical signal is equal to or less than a certain value K (step St11).

If the wavelength interval is equal to or less than the certain value K (Yes in step St11), the WSS controller 15 stops control of the wavelength (that is, changing the wavelength) of the optical signal (step St14). More particularly, the WSS controller 15 requests the LD controller 11 to stop the wavelength control, and performs processing of step St13 described below. Thereby, the wavelength is inhibited from being changed, until the limitation on the wavelength interval is exceeded.

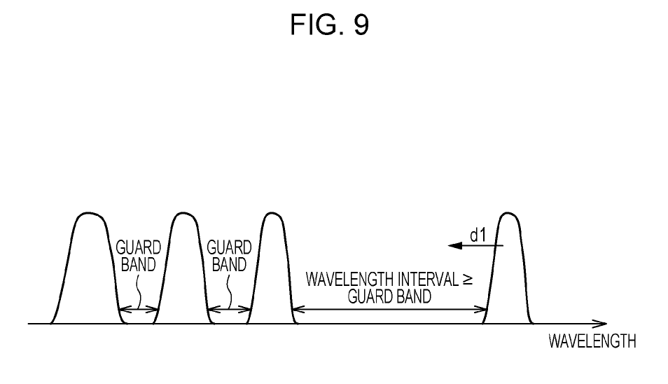

FIG. 9 illustrates a limitation on the wavelength interval. The wavelength interval (or frequency interval) between optical signals is maintained to be on or above a limiting value in order to avoid linear crosstalk and non-linear crosstalk that occur because spectra of optical signals overlap. This limiting value is called a guard band or the like.

The WSS controller 15 monitors the wavelength interval between optical signals using the OCM 14 so that the wavelength interval is maintained to be equal to or larger than the guard band, and stops wavelength control when the wavelength interval is equal to or less than the certain value K. At this point, the certain value K is determined in accordance with the guard band. Thereby, the waveform of an optical signal is inhibited from degradation caused by the crosstalk mentioned above.

Otherwise, if the wavelength interval is not equal to or less than the certain value K (No in step St11), the WSS controller 15 determines whether an unused passband generated by a change in the wavelength of the optical signal is present or absent (step St12). That is, the WSS controller 15 determines whether an unused passband having a certain width (for example, on a grid-by-grid basis) has been generated by the movement of the spectrum of the optical signal caused by wavelength control.

If the unused passband is present (Yes in step St12), the WSS controller 15 reduces the passband BW in accordance with a change in wavelength (step St13). This is as described with reference to FIG. 5D.

Otherwise, if the unused passband is absent (No in step St12), the WSS controller 15 terminates the process. In such a way, the process of reducing the passband BW is performed.

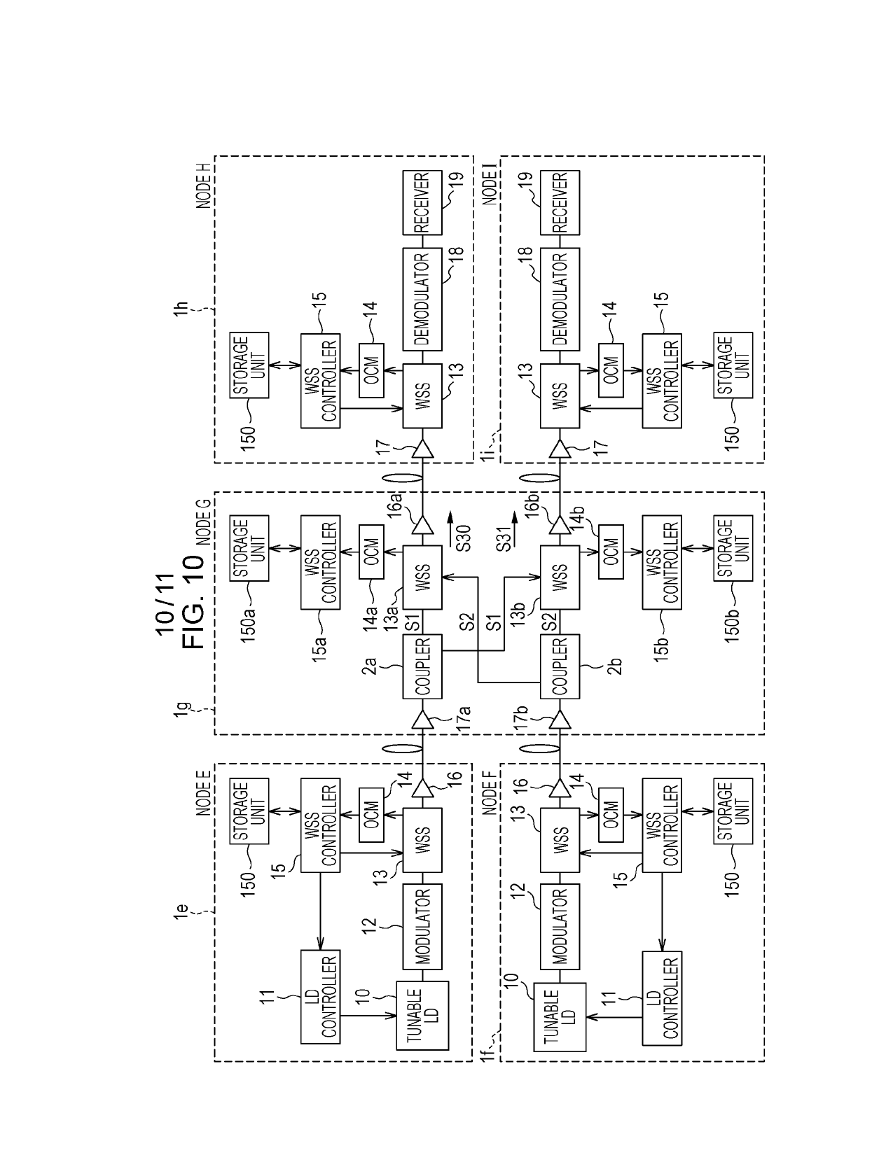

Next, with reference to FIG. 10, details of the wavelength selective switch 13 will be described. FIG. 10 is a schematic block diagram illustrating a configuration of a transmission system according to another embodiment. In FIG. 10, the configuration in common with that in FIG. 4 is denoted by the same reference characters, and redundant description thereof is omitted.

The optical transmission system has a plurality of optical transmission devices 1e to 1i arranged at the nodes E to I, respectively. The optical transmission devices 1e to 1i are connected through transmission paths (optical fiber).

The node E and the node F are sending nodes, the node G is a relay node, and the node H and the node I are receiving nodes. In this configuration, the optical transmission device 1e of the node E transmits optical signals through the optical transmission device 1g of the node G to the optical transmission devices 1h and 1i of the node H and the node I. Also, the optical transmission device 1f of the node F transmits optical signals through the optical transmission device 1g of the node G to the optical transmission devices 1h and 1i of the node H and the node I. Note that although the optical transmission devices 1e to 1i of the nodes E to I have a common configuration, configurations slightly different from one another are illustrated for the nodes A to D in FIG. 10 for the sake of convenience.

The optical transmission devices 1e and 1f of the node E and the node F each include the tunable laser diode 10, the LD controller 11, the modulator 12, the wavelength selective switch 13, the OCM 14, the WSS controller 15, the storage unit 150, and the output amplifier 16. The optical transmission devices 1h and 1i of the node H and the node I each include the input amplifier 17, the wavelength selective switch 13, the OCM 14, the WSS controller 15, the storage unit 150, the demodulator 18, and the receiver 19.

The optical transmission device 1g of the node G includes input amplifiers 17a and 17b, couplers 2a and 2b, wavelength selective switches 13a and 13b, OCMs 14a and 14b, WSS controllers 15a and 15b, storage units 150a and 150b, and output amplifiers 16a and 16b. The optical transmission device 1e 1g of the node G has a configuration suitable for two sets of input routes and output routes.

The input amplifiers 17a and 17b have functions similar to that of the input amplifier 17 mentioned above. The input amplifiers 17a and 17b amplify multiplexed optical signals input from the optical transmission devices 1e and 1f of the node E and the node F and output them to couplers 2a and 2b, respectively.

The couplers 2a and 2b function as optical demultiplexers that separate (demultiplex) multiplexed optical signals. One coupler 2a outputs separated, multiplexed optical signals S1 to the wavelength selective switches 13a and 13b, and the other coupler 2b outputs separated, multiplexed optical signals S2 to the wavelength selective switches 13a and 13b.

The wavelength selective switches 13a and 13b have functions similar to that of the wavelength selective switch 13 described above, and function as wavelength filters that each allow passage of optical signals having a selected wavelength among a plurality of wavelengths. The wavelength selective switches 13a and 13b each multiplex optical signals having a selected wavelength, and output them as multiplexed optical signals S30 and S31 to the output amplifiers 16a and 16b, respectively.

The output amplifiers 16a and 16b have functions similar to that of the output amplifier 16 described above. The output amplifiers 16a and 16b amplify multiplexed optical signals input from the wavelength selective switches 13a and 13b, and output them to transmission paths, respectively.

The WSS controllers (controllers) 15a and 15b have functions similar to that of the WSS controller 15 described above. The WSS controllers 15a and 15b autonomously control the passbands of the wavelength selective switches (wavelength filters) 13a and 13b, without depending on control of an external control device.

Like the storage unit 150 described above, the storage units 150a and 150b are storage units, such as memories, for example, and store the wavelengths of optical signals that are allowed to pass through the wavelength selective switches 13a and 13b.

The OCMs (monitors) 14a and 14b have functions similar to that of the OCM 14 described above. The OCMs 14a and 14b monitor optical signals output to transmission paths at certain time intervals.

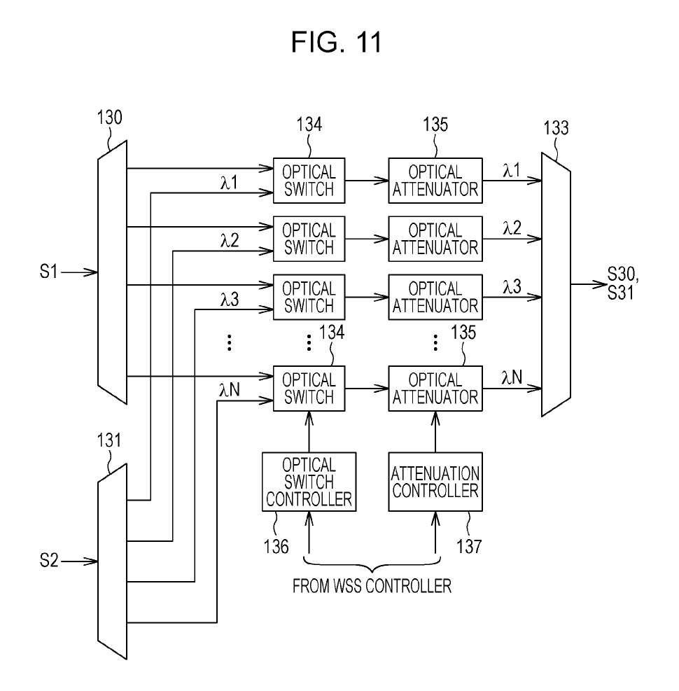

FIG. 11 is a schematic block diagram illustrating an example of a functional configuration of each of the wavelength selective switches 13a and 13b. The multiplexed optical signals S1 and S2 are input from the couplers 2a and 2b through two input ports to each of the wavelength selective switches 13a and 13b. The wavelength selective switches 13a and 13b each include demultiplexers 130 and 131, a plurality of optical switches 134, a plurality of optical attenuators 135, an optical multiplexer 133, an optical switch controller 136, and an attenuation controller 137.

The optical multiplexers 130 and 131, each of which is, for example, arrayed waveguide grating (AWG), divide the multiplexed optical signals S1 and S2 into optical signals for every wavelength and output the optical signals to the plurality of optical switches 134. The plurality of optical switches 134 are arranged for respective wavelength numbers λ1 to λN corresponding to the wavelengths of optical signals, and each of the optical switches 134 selects the optical multiplexer 130 or 131 from which the optical signals in question were input, from the optical multiplexers 130 and 131, under control of the optical switch controller 136. That is, the plurality of optical switches 134 each selects the input port of an optical signal.

The optical switch controller 136 controls the plurality of optical switches 134 based on control of the WSS controllers 15a and 15b. More particularly, the optical switch controller 136 is notified of detection of a change in the wavelength of an optical signal by the WSS controller 15a or 15b, and performs control so as to select an input port for each optical switch 134 in accordance with the change in wavelength.

For example, when the wavelength of an optical signal changes from a wavelength corresponding to the wavelength number λ1 to a wavelength corresponding to the wavelength number λ2, the optical switch controller 136 sets an input port for the optical switch 134 of the wavelength number λ1 as the input port for the optical switch 134 of the wavelength number λ2. Also, when the wavelength of an optical signal changes from the wavelength corresponding to the wavelength number λ2 to the wavelength corresponding to the wavelength number λ3, the optical switch controller 136 sets the input port for the optical switch 134 of the wavelength number λ2 as the input port for the optical switch 134 of the wavelength number λ3.

In such a way, the optical switch controller 136 controls the optical switch 134 so that the input port remains the same before and after the wavelength of an optical signal is changed. The optical switch 134 outputs an optical signal to the optical attenuator 135.

A plurality of optical attenuators 135 attenuate optical signals input from a plurality of respective optical switches 134. The attenuations of the optical attenuators 135 are individually set for the respective wavelengths.

The attenuation controllers 137 control the attenuations of all the optical attenuators 135 based on control of the WSS controllers 15a and 15b. More particularly, the attenuation controller 137 is notified of detection of a change in the wavelength of an optical signal by the WSS controller 15a or 15b, and controls an attenuation of each optical attenuator 135 in accordance with the change in wavelength. The attenuation controller 137 controls the attenuations of the optical attenuators 135, thereby controlling the passbands BW of the wavelength selective switches (wavelength filters) 13a and 13b.

For example, when the wavelength of an optical signal changes from a wavelength corresponding to the wavelength number λ1 to a wavelength corresponding to the wavelength number λ2, the attenuation controller 137 performs control by setting the attenuation of the optical attenuator 135 corresponding to the wavelength number λ1 for the optical attenuator 135 corresponding to the wavelength number λ2. Also, when the wavelength of an optical signal changes from the wavelength corresponding to the wavelength number λ2 to a wavelength corresponding to the wavelength number λ3, the attenuation controller 137 performs control by setting the attenuation of the optical attenuator 135 corresponding to the wavelength number λ2 for the optical attenuator 135 corresponding to the wavelength number λ3.

In such a way, the attenuation controller 137 expands the passband by setting the attenuation of the optical attenuator 135 in accordance with the wavelength before a change for the optical attenuator 135 in accordance with a wavelength after the change. The attenuation controller 137 reduces the passband based on control of the WSS controller 15a or 15b. In this case, the attenuation controller 137 maximizes the attenuation of the optical attenuator 135 in accordance with a passband to be reduced, thereby cutting off that passband. The plurality of optical attenuators 135 each output an optical signal to the optical multiplexer 133.

The optical multiplexer 133, which is, for example, AWG, multiplexes optical signals respectively input from the plurality of optical attenuators 135. The optical multiplexer 133 outputs the multiplexed optical signals S30 and S31 obtained by the multiplexing to the output amplifier 16a or 16b.

As described above, the optical transmission devices 1a to 1i according to the embodiments include wavelength filters (wavelength selective switches) 13, 13a, and 13b, the monitors (OCMs) 14, 14a, and 14b, and the controllers (WSS controllers) 15, 15a, and 15b. The wavelength filters 13, 13a, and 13b allow passage of optical signals having predetermined bands. The monitors 14, 14a, and 14b monitor optical signals.

The controllers (WSS controllers) 15, 15a, and 15b detect changes in the wavelengths of the optical signals using monitoring results of the monitors 14, 14a, and 14b, predict, based on results of the detecting, directions of change in the wavelengths of the optical signals, and expand the passbands of the wavelength filters 13, 13a, and 13b in the directions of the changes. Therefore, the passband of the wavelength filter 13 is expanded prior to wavelength control. That is, the passband is expanded before the spectrum of an optical signal moves outside of the passband of the wavelength filter 13 because of the change in wavelength. Accordingly, the wavelength of an optical signal may be changed even during operation, without being accompanied by instantaneous disruption of the optical signal.

The optical transmission systems according to the embodiments have first optical transmission devices 1a, 1e, and 1f and second optical transmission devices 1b to 1d and 1g to 1i connected to each other through optical paths.

The first optical transmission devices 1a, 1e, and 1f include senders (tunable LDs) 10 that send optical signals whose wavelengths are variable to the second optical transmission devices 1b to 1d and 1g to 1i, and the wavelength controllers (LD controllers) 11 that control wavelengths of optical signals.

The second optical transmission devices 1b to 1d and 1g to 1i include the wavelength filters (wavelength selective switches) 13, 13a, and 13b, the monitors (OCMs) 14, 14a, and 14b, and the controllers (WSS controller) 15, 15a, and 15b. The wavelength filters 13, 13a, and 13b allow passage of optical signals. The monitors 14, 14a, and 14b monitor optical signals.

The controllers 15, 15a, and 15b detect changes in the wavelengths of the optical signals using monitoring results of the monitors 14, 14a, and 14b, predict, based on results of the detecting, directions of change in the wavelengths caused by control of the wavelength controllers 11, and expand the passbands of the wavelength filters 13, 13a, and 13b in the control directions.

The optical transmission systems according to the embodiments have configurations similar to those of the optical transmission devices 1a to 1i according to the embodiments, and therefore have advantages similar to the contents described above.

An optical transmission method according to an embodiment is a method for transmitting an optical signal having a predetermined band, and includes the following:

(1) detecting a change in wavelength of the optical signal,

(2) predicting a direction of change in the wavelength of the optical signal, based on a result of the detecting, and

(3) expanding, in the direction of change, the passband BW of the wavelength filter 13 configured to allow passage of the optical signal.

The optical transmission method according to the embodiment has a configuration similar to those of the optical transmission devices 1a to 1i according to the embodiments, and therefore have advantages similar to the contents described above.

While, as described above, the contents of the present disclosure have been specifically described with reference to preferred embodiments, it will be obvious that various modified forms may be employed by any person skilled in the art based on the basic technical idea and teaching of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission device, comprising:
a wavelength filter configured to allow passage of an optical signal having a band;
a monitor configured to monitor a wavelength of the optical signal; and
a controller configured to detect, based on a monitoring result of the monitor, a change in the wavelength of the optical signal, to predict, based on a result detected by the monitor, a direction of the change in the wavelength of the optical signal, and to expand a passband of the wavelength filter in the direction of the change.

2. The optical transmission device according to claim 1,
wherein the controller is configured to reduce the expanded passband in accordance with the changed wavelength of the optical signal.

3. The optical transmission device according to claim 1,
wherein the controller is configured to detect, a monitoring result of the monitor, a speed of the change in wavelength, to determine, based on the speed of the change in wavelength, an amount of expansion of the passband, and to expand the passband in accordance with the amount of expansion.

4. The optical transmission device according to claim 1,
wherein the monitor is configured to monitor a power of noise light passing through the wavelength filter, and
wherein the controller is configured to, after expanding the passband, inspect the wavelength filter, based on the power of the noise light obtained from the monitor, and to, when detecting an abnormality of the wavelength filter, stop changing the wavelength of the optical signal.

5. The optical transmission device according to claim 1,
wherein the controller is configured to, based on a monitoring result of the monitor, stop changing the wavelength of the optical signal when a wavelength interval between the optical signal and another optical signal whose spectrum is adjacent to a spectrum of the optical signal is equal to or less than a certain value.

6. An optical transmission system, comprising
a first optical transmission device and a second optical transmission device connected to each other through a transmission path, wherein
the first optical transmission device includes
a sender configured to send, to the second optical transmission device, an optical signal whose wavelength is variable and that has a predetermined band, and
a wavelength controller configured to control the wavelength of the optical signal, and
the second optical transmission device includes
a wavelength filter configured to allow passage of the optical signal,
a monitor configured to monitor the optical signal, and
a controller configured to detect a change in wavelength of the optical signal using a monitoring result of the monitor, to predict, based on a result of the detecting, a direction of change in wavelength caused by the wavelength controller, and to expand a passband of the wavelength filter in the direction of change.

7. The optical transmission system according to claim 6,
wherein the controller is configured to reduce the expanded passband in accordance with a changed wavelength of the optical signal.

8. The optical transmission system according to claim 6,
wherein the controller is configured to detect a speed of the change in wavelength using a monitoring result of the monitor, to determine, based on the speed of the change in wavelength, an amount of expansion of the passband, and to expand the passband in accordance with the amount of expansion.

9. The optical transmission system according to claim 6,
wherein the monitor is configured to monitor a power of noise light passing through the wavelength filter, and
wherein the controller is configured to, after expanding the passband, inspect the wavelength filter, based on the power of the noise light obtained from the monitor, and to, upon detection of an abnormality of the wavelength filter, stop control of the wavelength of the optical signal.

10. The optical transmission system according to claim 6,
wherein the controller is configured to, based on a monitoring result of the monitor, stop control of the wavelength of the optical signal when a wavelength interval between the optical signal and another optical signal whose spectrum is adjacent to a spectrum of the optical signal is equal to or less than a certain value.

11. An optical transmission method of transmitting an optical signal having a band, comprising:
detecting a change in wavelength of the optical signal;
predicting a direction of the change, based on a detected result in the detecting; and
expanding, in the direction of the change, a passband of a wavelength filter being configured to allow passage of the optical signal.

12. The optical transmission method according to claim 11,
wherein the expanded passband is reduced in accordance with a changed wavelength of the optical signal.

13. The optical transmission method according to claim 11,
wherein a speed of the change in the wavelength is detected, an amount of expansion of the passband is determined based on the speed of the change in the wavelength, and the passband is expanded in accordance with the amount of the expansion.

14. The optical transmission method according to claim 11,
wherein the wavelength filter is inspected based on a power of noise light passing through the wavelength filter, and changing of the wavelength of the optical signal is stopped when an abnormality of the wavelength filter is detected.

15. The optical transmission method according to claim 11,
wherein changing of the wavelength of the optical signal is stopped when a wavelength interval between the optical signal and another optical signal whose spectrum is adjacent to a spectrum of the optical signal is equal to or less than a certain value.
